(19) United States
(12) Patent Application Publication
(10) Pub. No.: US 2016/0258194 A1
(43) Pub. Date: Sep. 8, 2016

(54) MOTOR VEHICLE LOCK

(71) Applicant: Brose Schliesssysteme GmbH & Co. KG, Wuppertal (DE)

(72) Inventors: David Rosales, Rochester Hills, MI (US); Michael Wittelsbuerger, Lake Orion, MI (US); Stepan Hanke, Lake Orion, MI (US)

(21) Appl. No.: 15/053,142

(22) Filed: Feb. 25, 2016

Related U.S. Application Data
(60) Provisional application No. 62/129,555, filed on Mar. 6, 2015.

(51) Int. Cl. E05B 77/06; E05B 85/24; E05B 79/10; E05B 85/26

(52) U.S. Cl. CPC E05B 77/06; E05B 85/26; E05B 85/243; E05B 79/10

(57) ABSTRACT

Described is a vehicle lock, wherein a catch and a pawl are provided, wherein the catch may be brought into holding engagement with a lock striker, wherein the pawl may be brought into an engagement position, wherein the pawl is deflected into a release position, wherein an actuation lever is provided for deflecting the pawl into the release position, wherein a switchable lock arrangement is provided in an actuation drive train between the actuation lever and the pawl, wherein an actuation movement of the actuation lever deflects the pawl and, a drive train component of the actuation drive train is decoupled from the pawl for letting the actuation movement of the actuation lever run free without deflecting the pawl or a drive train component is blocked for blocking an actuation movement of the actuation lever, wherein a predetermined crash condition switches the switchable lock arrangement to the locked state.

### CLAIM OF PRIORITY

This application claims the benefit of U.S. Provisional Application No. 62/129,555, filed Mar. 6, 2015, the content of which is herein incorporated by reference in its entirety.

### FIELD OF THE TECHNOLOGY

The application is directed to a motor vehicle lock for a motor vehicle door arrangement.

### BACKGROUND

The motor vehicle lock in question is assigned to a motor vehicle door arrangement which comprises at least a motor vehicle door. The expression “motor vehicle door” is to be understood in a broad sense. It includes in particular side doors, back doors, lift gates, trunk lids or engine hoods. Such a motor vehicle door may generally be designed as a sliding door as well.

Crash safety plays an important role for today's motor vehicle locks. It is of particular importance that neither crash induced acceleration nor crash induced deformation leads to an unintended opening of the motor vehicle door to which the motor vehicle lock is assigned. The focus of the present application is to prevent an unintended opening of the motor vehicle door based on crash induced acceleration. In case of a side impact on the motor vehicle the outer door handle may be reluctant to follow the impact due to mass inertia of the outer door handle. As a result, a relative movement between the outer door handle and the motor vehicle door occurs, which again may lead to an unintended opening of the motor vehicle door.

The known motor vehicle lock (US 2011/018 1052 A1), which is the starting point for the invention, is provided with the usual locking elements catch and pawl, wherein the pawl may be deflected into a release position by actuation of an actuation lever.

The known motor vehicle lock also comprises a central lock arrangement which may be brought into different functional states such as “unlocked” and “locked” by the user. The pawl may be deflected into its released position by an outer door handle which is connected to the actuation lever, if the lock mechanism is in its unlocked state. With the lock mechanism being in its locked state an actuation of the actuation lever runs free.

To guarantee a high crash safety the known motor vehicle lock comprises a crash element which is a separate component from the actuation lever. By the accelerations which occur during a crash the crash element moves into a blocking position in which the crash element blocks further actuation of the actuation lever.

One disadvantage of the known motor vehicle lock and particularly of its crash safety behavior is the observation that there may be secondary impacts in a crash situation, i.e. after the occurrence of the first crash impact, which are not as strong as the first crash impact. In fact, they may remain below the threshold triggering the crash safety feature and therefore cause the pawl to be deflected into its released position, with the result being the undesired opening of the motor vehicle door during the crash situation. What is desired from the point of view of safety is for the motor vehicle door not to be opened—and consequently the pawl not to be deflected—for the entire duration of the crash situation, even if technically any secondary impacts in the crash situation are not as strong as the first crash impact and would not normally activate the crash safety on their own.

### SUMMARY

It is the object of the invention to improve the known motor vehicle lock in a cost-effective way such that, once a crash situation occurs, also secondary impacts in a crash situation do not cause the pawl to be deflected into the release position.

The above noted object is solved for a motor vehicle lock as described herein.

Underlying the invention is the realization that the central lock arrangement of the motor vehicle lock, which can be brought at least into a locked state and an unlocked state, already provides a structure which may be utilized to achieve the desired outcome with regard to crash behavior. To wit, by switching the central lock arrangement to the locked state on the first occurrence of the crash condition, any subsequent secondary impacts will also be prevented from deflecting the pawl, even if they are much lesser strength. The proposed solution is thus not only reliable but all the more attractive for being cost-effective in implementation, precisely because it relies for its principal functionality on the central lock arrangement already provided for in the motor vehicle lock.

An embodiment provides a further simplification in terms of construction in that the proposed crash safety mechanism acts on the same central locking lever by which also a user-actuated switching of the central lock arrangement is effected.

Various embodiments include the engagement of the central lock arrangement, is achieved by an additional inertial lever which is coupled—at least indirectly—with the actuation lever. Accordingly, such a solution requires only this additional inertial lever and at most an additional bias spring and therefore only few additional components. Such an inertial lever can also be made of plastic. Thus, both additional production costs and additional weight for the motor vehicle lock are modest.

Here, a particularly compact construction can be achieved if this inertial lever is pivotably coupled to the actuation lever. In this way, the inertial lever may be placed such that there are no additional packaging requirements within the plane in which actuation lever moves, which is generally the critical plane in terms of packaging constraints.

In an embodiment, the inertial lever may be arranged such that, in the absence of a crash condition, the inertial lever runs free. Thereby, the provision of the inventive crash safety mechanism has little effect on the functioning of the motor vehicle lock during normal operation. Such an approach makes it possible to use lower tolerances for the parts involved.

The dependence on the rapidity of the actuation movement of whether or not the inertial lever runs free or engages the central lock arrangement may advantageously be balanced by the choice of the inertial characteristics of the inertial lever on the one hand and an opposed pre-stress on the other hand. By the selection of these characteristics also the rapidity threshold may be adjusted.

In an embodiment, a central locking drive of the central lock arrangement may be utilized for resetting the central lock arrangement after the occurrence of a crash condition.

An embodiments provides a motor vehicle lock for a motor vehicle door arrangement, wherein a catch and a pawl, which is assigned to the catch, are provided, wherein the catch can be brought into an open position and into a closed position, wherein the catch, which is in the closed position, is or may be brought into holding engagement with a lock striker, wherein the pawl may be brought into an engagement position, in which it is in blocking engagement with the catch, wherein the pawl may be deflected into a release position, in which it releases the catch, wherein an actuation lever is provided for deflecting the pawl into the release position, wherein a switchable lock arrangement is provided in an actuation drive train between the actuation lever and the pawl, wherein the switchable lock arrangement may be brought into a “locked state” and into an “unlocked state”, wherein the locked state and the unlocked state of the switchable lock arrangement are stable, wherein, with the switchable lock arrangement being in the unlocked state, an actuation movement of the actuation lever deflects the pawl and, with the switchable lock arrangement being in the locked state, a drive train component of the actuation drive train is decoupled from the pawl for letting the actuation movement of the actuation lever run free without deflecting the pawl or a drive train component is blocked for blocking an actuation movement of the actuation lever, wherein a predetermined crash condition switches the switchable lock arrangement to the locked state, wherein the switchable lock arrangement is a user-switchable central lock arrangement.

In an embodiment, the drive train component is the actuation lever.

In an embodiment, the predetermined crash condition is based on a rapidity threshold with regard to the actuation movement of the actuation lever.

In an embodiment, the switchable lock arrangement is switched to the locked state on the predetermined crash condition by engaging a central locking lever of the switchable lock arrangement. In an embodiment, the motor vehicle lock arrangement comprises a central lock actuation element for engaging the central locking lever and switching the switchable lock arrangement to the locked state, wherein the central lock actuation element can be actuated by a user for switching the switchable lock arrangement to the locked state.

In an embodiment, wherein an inertial lever is provided, which inertial lever is coupled with the actuation lever such that actuation of the actuation lever actuates the inertial lever. In an embodiment, the inertial lever is configured for engaging the switchable lock arrangement and switching it to the locked state on actuation of the actuation lever during the crash condition.

In an embodiment, the inertial lever is configured to engage the central locking lever for switching, such as moving, the central locking lever to the locked state on actuation of the pawl actuation lever during the crash condition.

In an embodiment, the inertial lever is pivotably coupled to the actuation lever. In an embodiment, the inertial lever is configured for pivoting around an inertial lever pivot axis and is coupled to the actuation lever at the inertial lever pivot axis, in particular, wherein the actuation lever is configured for pivoting around a pawl actuation pivot axis, which pawl actuation pivot axis is offset from the inertial lever pivot axis.

In an embodiment, the inertial lever pivot axis is arranged on the actuation lever between the pawl actuation pivot axis and an engagement point of the actuation lever, wherein a door handle, in particular an outer door handle, is coupled to the actuation lever at the engagement point for causing the actuation movement of the actuation lever.

In an embodiment, the inertial lever can be brought into an engagement position in which the inertial lever engages the switchable lock arrangement, in particular the central locking lever, and switches the switchable lock arrangement to the opening state on actuation of the pawl actuation lever during the crash condition. In an embodiment, the inertial lever can be brought into a free-running position in which the inertial lever runs free without engaging the switchable lock arrangement, in particular, wherein the inertial lever is brought into the free-running position on actuation of the actuation lever in the absence of the crash condition.

In an embodiment, the inertial lever can be brought into the engagement position from the free-running position and vice versa via a pivoting movement. In an embodiment, the inertial lever is pre-stressed, in particular spring-biased, toward the free-running position.

In an embodiment, the inertial lever is arranged such that increasing rapidity of the actuation movement of the actuation lever and/or increasing rapidity of the actuation movement of the inertial lever, urges the inertial lever toward the engagement position.

In an embodiment, the inertial lever has an inertial characteristic which is configured to move or hold the inertial lever to or at the engagement position when the actuation movement of the actuation lever surpasses the rapidity threshold. In an embodiment, the inertial characteristic of the inertial lever is balanced such with the pre-stress of the inertial lever toward the free-running position that the inertial lever is moved to the free-running position during the actuation movement of the actuation lever when the actuation movement of the actuation lever is below the rapidity threshold.

In an embodiment, the actuation lever is pre-stressed, such as spring-biased, to an actuation lever rest position and that a reset contour is provided which is configured to engage the inertial lever when the actuation lever is in the actuation lever rest position and to force the inertial lever to the engagement position.

In an embodiment, during a return movement of the actuation lever to the actuation lever rest position after the actuation movement of the actuation lever the switchable lock arrangement remains in its state.

In an embodiment, the motor vehicle lock comprises a central locking drive with a central locking motor for switching the switchable lock arrangement between the locked state and the unlocked state, such as for a user-actuated switching between the locked state and the unlocked state.

### BRIEF DESCRIPTION OF THE FIGURES

In the following the invention will be described in an example referring to the drawings. In the drawings it is shown in

FIG. 1 the relevant parts of a proposed motor vehicle lock in a top view with the pawl in an engagement position with the catch and the switchable lock arrangement in the “unlocked state”,

FIG. 2 the motor vehicle lock according to FIG. 1 in the top view after an actuation of the actuation lever during normal operation and

FIG. 3 the motor vehicle lock according to FIG. 1 in the top view after an actuation of the actuation lever in a crash situation.

### DETAILED DESCRIPTION

The motor vehicle lock 1 shown in the drawings is assigned to a motor vehicle door arrangement, which comprises a motor vehicle door (not shown) beside said motor vehicle lock 1. Regarding the broad interpretation of the expression “motor vehicle door” reference is made to the introductory part of the specification. Here the motor vehicle door is a side door of a motor vehicle.

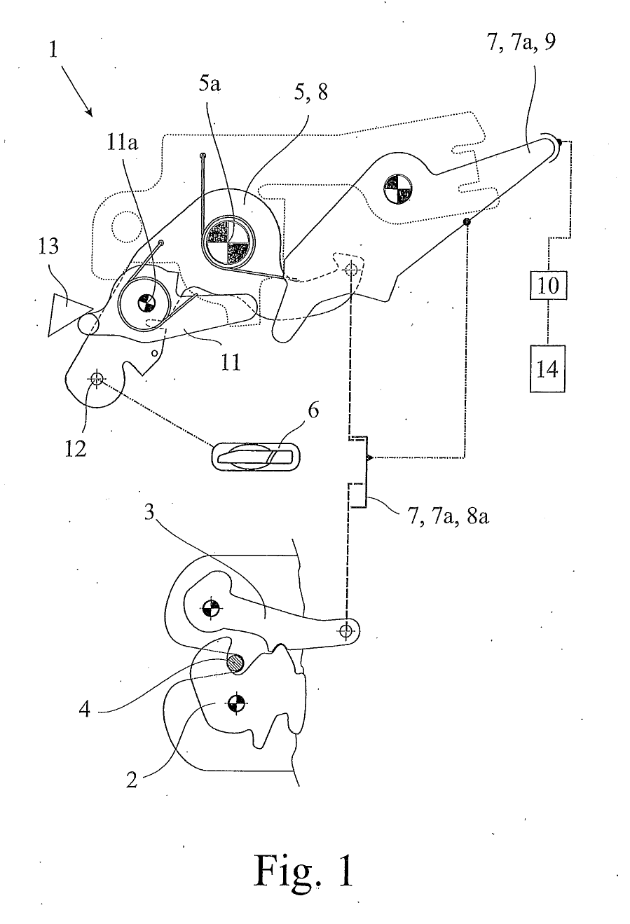

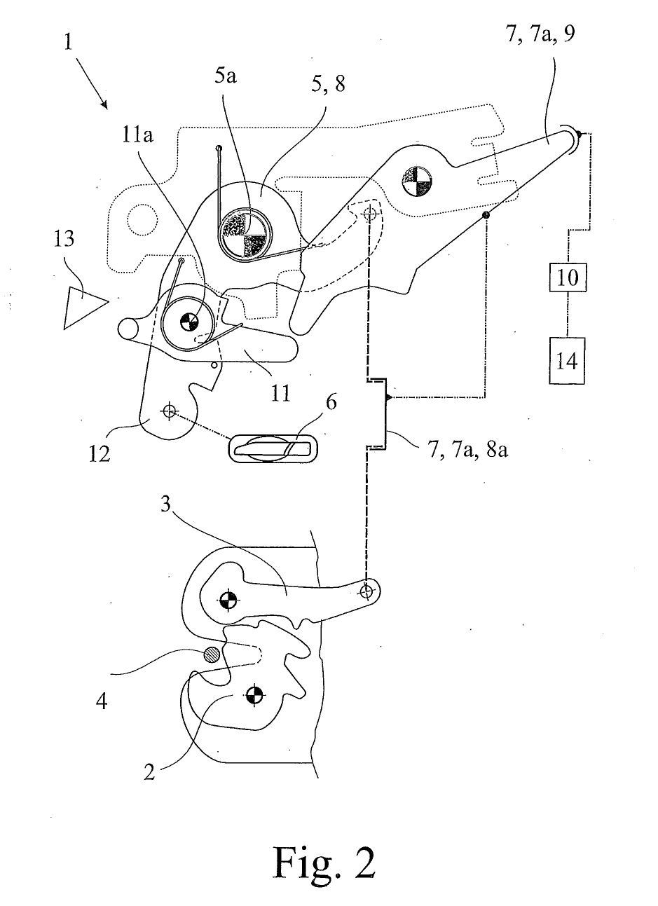

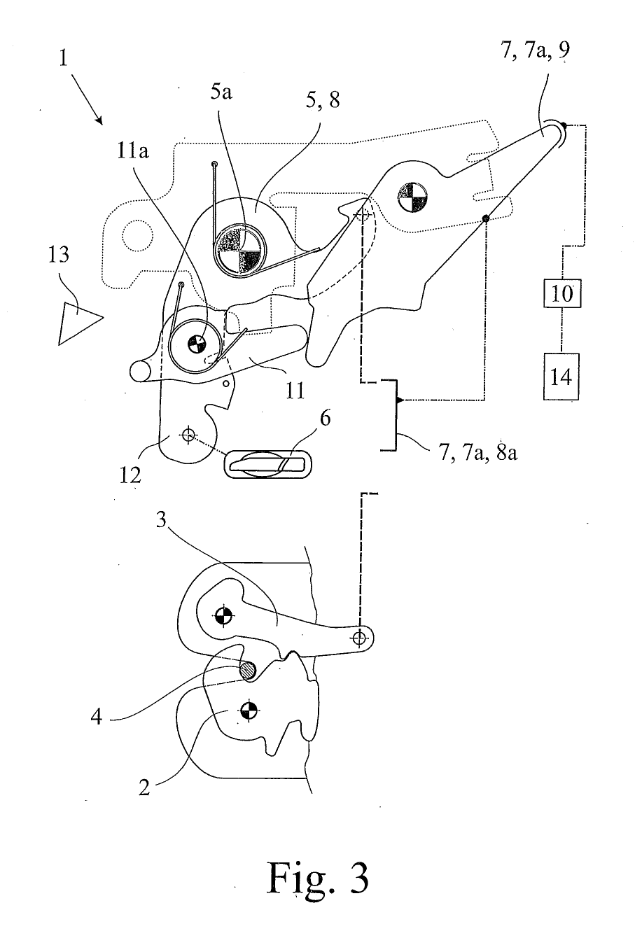

The motor vehicle lock 1 comprises the usual locking elements catch 2 and pawl 3, which pawl 3 is assigned to the catch 2. Both the catch 2 and the pawl 3 are shown in a schematic presentation. The catch 2 can be brought into an open position, shown schematically in FIG. 2, and into a closed position, shown schematically in FIG. 1 and 3. In the closed position the catch 2 is or may be brought into holding engagement with a lock striker 4 that is indicated in FIGS. 1 to 3 as well. The motor vehicle lock 1 is normally arranged at or in the motor vehicle door, while the lock striker 4 is arranged at the motor vehicle body.

The pawl 3 may be brought into an engagement position shown in FIGS. 1 and 3, in which it is in blocking engagement with the catch 2. Here the pawl 3 blocks the catch 2 in its closed position in a mechanically stable mariner such that the pawl 3 itself does not have to be blocked. For release of the catch 2 into its open position the pawl 3 may be deflected into a release position shown in FIG. 2, which would be a deflection in the anti-clockwise direction from the situation in FIG. 1.

An actuation lever 5 is provided for deflecting the pawl 3 into the release position. The actuation lever 5 may engage the pawl 3 for deflection either directly or—as in the present embodiment—indirectly. The actuation lever 5 may be coupled to a door handle 6, which is also shown schematically in FIG. 1 to 3, optionally to an outer door handle, such that the assigned motor vehicle door may be opened by actuating the door handle 6. Thus, the actuation lever 5 may be understood to be an outer release lever.

Further, a switchable lock arrangement 7 is provided in an actuation drive train between the actuation lever 5 and the pawl 3. In this actuation drive train between the actuation lever 5 and the pawl 3, any number of elements such as levers may be provided. It may also be that the actuation drive train consists of the actuation lever 5 and the pawl 3 themselves.

The switchable lock arrangement 7 may be brought into a locked state and into an unlocked state, wherein the locked state and the unlocked state of the switchable lock arrangement 7 are stable. These states, comprising the locked state and the unlocked state, may also be called “functional states”. That the states are stable means that, when the switchable lock arrangement 7 is either in the locked state or in the unlocked state, it remains stable in the respective state out of its own accord until further actuation. In an embodiment, the switchable lock arrangement 7 may be brought into any number of further such functional states such as “double-locked”, “theft-protected” or “child-locked”.

When for the motor vehicle lock 1 according to the proposal the switchable lock arrangement 7 is in the above unlocked state, an actuation movement of the actuation lever 5 deflects the pawl 3. On the other hand, when the switchable lock arrangement 7 is in the above locked state, a drive train component 8 of the actuation drive train is decoupled from the pawl 3 for letting the actuation movement of the actuation lever 5 run free without deflecting the pawl 3 or a drive train component 8 is blocked for blocking an actuation movement of the actuation lever 5. Therefore, the locked state in the present sense may refer to any or all of the functional states “central locked”, “double locked” or “theft-protected”, i.e. to all functional states in which a deflection of the pawl by actuation of the outer door handle is prevented.

For the embodiment shown in FIG. 1 to 3, the drive train component 8 of the actuation drive train is decoupled from the pawl 3 for letting the actuation movement of the actuation lever 5 run free without deflecting the pawl 3. Here, this drive train component 8 is the actuation lever 5. The respective decoupling or coupling of the drive train component 8 is schematically represented in the Figures by a coupling arrangement 8a.

Further, according to the proposal a predetermined crash condition switches the switchable lock arrangement 6 to the locked state. This will be explained in further detail below.

It is essential for the present invention that the switchable lock arrangement 7 is a user-switchable central lock arrangement 7a. That is, the switchable lock arrangement 7 is one which the user can switch, either directly or indirectly, either mechanically or electrically, between the locked state and the unlocked state. In other words, the switchable lock arrangement 7 is the arrangement used for locking and unlocking the motor vehicle lock 1—and thereby, by extension, the assigned motor vehicle door—during regular use, i.e. outside a crash situation. Thereby, the crash safety mechanism of the motor vehicle lock according to the invention relies on the central lock arrangement 7a already provided for regular use.

A way of defining the predetermined crash condition entails that the predetermined crash condition is based on a rapidity threshold with regard to the actuation movement of the actuation lever 5. Such a rapidity threshold may concern a velocity, speed or acceleration of the actuation lever 5. Thus, the predetermined crash condition may be defined to occur when any of these quantities exceeds the associated rapidity threshold. For a quantity associated with a direction, e.g. for velocity, the threshold may relate to the magnitude of is that quantity or to a component of the quantity in a specific direction. In an embodiment, especially if the rapidity threshold concerns velocity or acceleration as a vector quantity, the rapidity threshold relates to the component of the velocity or acceleration in the direction of the actuation movement of the actuation lever 5. In other words, components of velocity or acceleration which are perpendicular to that direction of the actuation movement are disregarded with respect to the occurrence of the predetermined crash condition. This is significant because such a perpendicular component of velocity or acceleration may also arise due to a crash impact. In the present case, however, and as optionally only crash-induced velocity or acceleration in the direction of the actuation movement are relevant for the crash condition at hand

In an embodiment, the switchable lock arrangement 7 is switched to the locked state on the predetermined crash condition by engaging a central locking lever 9 of the switchable lock arrangement 7. Thus, the state of the switchable lock arrangement 7 can be determined by the position of the central locking lever 9 or corresponds to a respective position of the central locking lever 9. Thus, it may also be stated that the central locking lever 9 can be switched to the locked state or the unlocked state, respectively, which corresponds to a locked position or unlocked position of the central locking lever 9. Depending on its position, the central locking lever 9 may then let the actuation movement of the actuation lever 5 run free or not. In the Figures, this is represented by connecting the position of the central locking lever 9 to the coupling arrangement 8a.

In an embodiment, the motor vehicle lock arrangement comprises a central lock actuation element 10 for engaging the central locking lever 9 and switching the switchable lock arrangement 7 to the locked state, wherein the central lock actuation element 10 can be actuated by a user for switching the switchable lock arrangement 7 to the locked state. Such an actuation by a user can occur, on the one hand, by direct mechanical actuation. There may also be an actuating drive directly or indirectly controlled by the user, for which an example will be described further below.

In order to implement the crash behavior according to the proposal, an inertial lever 11 can be provided, which inertial lever 11 is coupled with the actuation lever 5 such that actuation of the actuation lever 5 actuates the inertial lever 11. This coupling may in principle be any kind of coupling which causes the inertial lever 11 to be actuated when the actuation lever 5 is actuated. In an embodiment, the inertial lever 11 is configured for engaging the switchable lock arrangement 7 and switching it to the locked state on actuation of the actuation lever 5 during the crash condition. The underlying mechanism for this can be seen by a comparison between FIG. 1—which depicts the situation prior to the crash, in which the switchable lock arrangement 7 is in the unlocked state—and FIG. 3, which shows the inertial lever 11 engaging the switchable lock arrangement 7 and switching it to the locked state.

As seen from the Figures, the inertial lever 11 can be configured to engage the central locking lever 9 for switching the central locking lever 9 to the locked state on actuation of the pawl actuation 5 lever during the crash condition. This switching can be done by moving the central locking lever 9.

To this end, an embodiment corresponding to that given in the Figures is characterized in that the inertial lever 11 is pivotably coupled to the actuation lever 5. Thereby, an actuation of the inertial lever 11 on actuation of the actuation lever 5 is effected. In particular, the inertial lever 11 is configured for pivoting around a inertial lever pivot axis 11a and is coupled to the actuation is lever 5 at the inertial lever pivot axis 11a. As also seen in the Figures, the actuation lever 5 can be configured for pivoting around a pawl actuation pivot axis 5a, which pawl actuation pivot axis 5a is offset from the inertial lever pivot axis 11a. This offset causes a dependence on the pivoting of the inertial lever 11 with respect to the actuation rapidity—corresponding to a pivoting rapidity—of the actuation lever 5.

A further variant also shown in the Figures is characterized in that the inertial lever pivot axis 11a is arranged on the actuation lever 5 between the pawl actuation pivot axis 5a and an engagement point 12 of the actuation lever 5, wherein the door handle 6—here the outer door handle mentioned above—is coupled to the actuation lever 5 at the engagement point 12 for causing the actuation movement of the actuation lever 5. In particular, there may be a Bowden cable or similar pulling apparatus, coupled at the engagement point 12 and not shown here, for actuating the actuation lever 5 on actuation of the door handle 6.

Looking more closely at the interaction of the inertial lever 11 with the central locking lever 9 as seen in FIG. 3, the inertial lever 11 can be brought into an engagement position in which the inertial lever 11 engages the switchable lock arrangement 7—here in particular the central locking lever 9—and switches the switchable lock arrangement 7 to the locked state on actuation of the pawl actuation 5 lever during the crash condition.

In contrast, the corresponding case with actuation of the actuation lever 5 without the occurrence of a crash condition is shown in FIG. 2 (starting from the initial position of FIG. 1). As can be seen from these Figures, the inertial lever 11 can be brought into a free-running position in which the inertial lever 11 runs is free without engaging the switchable lock arrangement 7. In particular, the inertial lever 11 can be brought into the free-running position on actuation of the actuation lever 5 in the absence of the crash condition.

It can also be readily seen by a comparison between FIG. 2 and FIG. 3 that according to the embodiment at hand, the inertial lever 11 can be brought into the engagement position from the free-running position and vice versa via a pivoting movement. This pivoting movement comprises pivoting of the inertial lever 11 around the inertial lever pivot axis 11a. In an embodiment, the inertial lever 11 is pre-stressed—specifically, spring-biased—toward the free-running position.

As can be seen from the Figures, there are two counteracting and thereby competing mechanisms at work for urging the inertial lever 11 to the engagement position on the one hand and to the free-running position on the other hand Their respective balancing thus establishes the above rapidity threshold, below which the actuation lever 5 deflects the pawl 3 on its actuation movement and above which the actuation lever 5 runs free on its actuation movement. The above-described re-stress urges the inertial lever 11 toward the free-running position.

On the other hand, the inertial lever 11 can be arranged such that increasing rapidity of the actuation movement of the actuation lever 5 urges the inertial lever 11 toward the engagement position. This is because, firstly, a more rapid actuation movement of the actuation lever 5 leaves less time for the inertial lever 11—pre-stressed toward the free-running position as described above—to complete its movement to the free-running position. Secondly, there is also a centripetal force effect urging the inertial lever 11 toward the engagement is position depending on the rapidity of the actuation movement 11. Because an increase in the rapidity of the actuation movement of the actuation lever 5 means also an increase in the rapidity of the actuation of the inertial lever, it can also be stated that the inertial lever is arranged such that increasing rapidity of the actuation movement of the inertial lever 11 urges the inertial lever 11 toward the engagement position.

This effect is based on inertial properties of the inertial lever 11. Consequently, the inertial lever 11 can have an inertial characteristic which is configured to move or hold the inertial lever 11 to or at the engagement position when the actuation movement of the actuation lever 5 surpasses the rapidity threshold.

This inertial characteristic comprises in particular a rotational inertia of the inertial lever 11. In an embodiment, this inertial characteristic of the inertial lever 11 is balanced such with the pre-stress of the inertial lever 11 toward the free-running position that the inertial lever 11 is moved to the free-running position during the actuation movement of the actuation lever 5 when the actuation movement of the actuation lever 5 is below the rapidity threshold. This corresponds to the sequence defined by FIGS. 1 and 2, in which the actuation lever 5 is actuated with a rapidity below the rapidity threshold, e.g. during normal operation outside a crash situation. It is to be pointed out that technically the rate at which the inertial lever 11 moves to the free-running position also depends on a rotational inertia of the inertial lever 11, albeit with a different axis of rotation than for the urge toward the engagement position, the axis of rotation here being given by the inertial lever pivot axis 11a. Thus, the pawl 3 is deflected due to the above actuation drive train being closed.

As far as the material composition of the inertial lever 11 is concerned, the inertial lever 11 can comprise a plastic material. The inertial lever 11 may also is consist of a plastic material. Thereby, the weight and the production costs of the inertial lever 11 are kept low. This also helps to provide little noticeable effect for the actuation of the actuation lever 5, i.e. in practice no significant additional energy has to be imparted to the actuation lever 5 for its actuation movement.

In order to have a defined starting position for the actuation movement of the actuation lever 5, the actuation lever 5 can be pre-stressed—such as spring-biased—to an actuation lever rest position and that a reset contour 13 is provided which is configured to engage the inertial lever 11 when the actuation lever 5 is in the actuation lever rest position and to force the inertial lever 11 to the engagement position. This effect of the reset contour 13 can be seen in particular in FIG. 1, in which FIG. 1 the actuation lever 5 is in the actuation lever rest position.

When the actuation lever 5 has completed its actuation movement, reaching the position corresponding to FIG. 2 or FIG. 3, respectively, the actuation lever 5 returns to the actuation lever rest position, shown in FIG. 1. This can be a result of e.g. the above pre-stressing or spring-biasing. In an embodiment, during a return movement of the actuation lever 5 to the actuation lever rest position after the actuation movement of the actuation lever 5 the switchable lock arrangement 7 remains in its state. Thereby, when the pawl actuation movement has resulted in switching the switchable lock arrangement 7 to the locked state, the switchable lock arrangement 7 remains in the locked state. A subsequent actuation of the actuation lever 5, even if not surpassing the rapidity threshold, will in any case run free or be blocked and consequently fail to deflect the pawl 3. Consequently and as desired, secondary impacts after a first occurrence of the predetermined crash condition do not cause unlocking of the motor vehicle lock.

is The utilization of the user-switchable central lock arrangement 7a according to the proposal has the further advantage of providing a convenient way of undoing the switching of the central lock arrangement 7a which has occurred due to the predetermined crash condition, namely by using the same mechanism as for a user-actuated switching of the central lock arrangement 7a. Therefore the motor vehicle lock 1 can comprise a central locking drive 14 with a central locking motor 14a for switching the switchable lock arrangement 7 between the locked state and the unlocked state. In an embodiment, this central locking drive 14 is for a user-actuated switching between the locked state and the unlocked state. Therefore, this central locking drive 14 can be used for switching back to the unlocked state. To this end, the central locking drive 14 may be configured for actuating the above central lock actuation element 10.

1. A motor vehicle lock for a motor vehicle door arrangement, wherein a catch and a pawl, which is assigned to the catch, are provided, wherein the catch can be brought into an open position and into a closed position, wherein the catch, which is in the closed position, is or may be brought into holding engagement with a lock striker, wherein the pawl may be brought into an engagement position, in which it is in blocking engagement with the catch, wherein the pawl may be deflected into a release position, in which it releases the catch, wherein an actuation lever is provided for deflecting the pawl into the release position, wherein a switchable lock arrangement is provided in an actuation drive train between the actuation lever and the pawl, wherein the switchable lock arrangement may be brought into a “locked state” and into an “unlocked state”, wherein the locked state and the unlocked state of the switchable lock arrangement are stable, wherein, with the switchable lock arrangement being in the unlocked state, an actuation movement of the actuation lever deflects the pawl and, with the switchable lock arrangement being in the locked state, a drive train component of the actuation drive train is decoupled from the pawl for letting the actuation movement of the actuation lever run free without deflecting the pawl or a drive train component is blocked for blocking an actuation movement of the actuation lever, wherein a predetermined crash condition switches the switchable lock arrangement to the locked state, wherein the switchable lock arrangement is a user-switchable central lock arrangement.

2. The motor vehicle lock according to claim 1, wherein the drive train component is the actuation lever.

3. The motor vehicle lock according to claim 1, wherein the predetermined crash condition is based on a rapidity threshold with regard to the actuation movement of the actuation lever.

4. The motor vehicle lock according to claim 3, wherein the switchable lock arrangement is switched to the locked state on the predetermined crash condition by engaging a central locking lever of the switchable lock arrangement.

5. The motor vehicle lock according to claim 1, wherein an inertial lever is provided, which inertial lever is coupled with the actuation lever such that actuation of the actuation lever actuates the inertial lever.

6. The motor vehicle lock according to claim 5, wherein the inertial lever is configured to engage the central locking lever for switching the central locking is lever to the locked state on actuation of the pawl actuation lever during the crash condition.

7. The motor vehicle lock according to claim 5, wherein the inertial lever is pivotably coupled to the actuation lever.

8. The motor vehicle lock according to claim 7, wherein the inertial lever pivot axis is arranged on the actuation lever between the pawl actuation pivot axis and an engagement point of the actuation lever, wherein a door handle, in particular an outer door handle, is coupled to the actuation lever at the engagement point for causing the actuation movement of the actuation lever.

9. The motor vehicle lock according to claim 5, wherein the inertial lever can be brought into an engagement position in which the inertial lever engages the switchable lock arrangement, in particular the central locking lever, and switches the switchable lock arrangement to the opening state on actuation of the pawl actuation lever during the crash condition.

10. The motor vehicle lock according to claim 9, wherein the inertial lever can be brought into the engagement position from the free-running position and vice versa via a pivoting movement.

11. The motor vehicle lock according to claim 9, wherein the inertial lever is arranged such that increasing rapidity of the actuation movement of the actuation lever.

12. The motor vehicle lock according to claim 11, wherein the inertial lever has an inertial characteristic which is configured to move or hold the inertial lever to is or at the engagement position when the actuation movement of the actuation lever surpasses the rapidity threshold.

13. The motor vehicle lock according to claim 5, wherein the actuation lever is pre-stressed to an actuation lever rest position and that a reset contour is provided which is configured to engage the inertial lever when the actuation lever is in the actuation lever rest position and to force the inertial lever to the engagement position.

14. The motor vehicle lock according to claim 13, wherein during a return movement of the actuation lever to the actuation lever rest position after the actuation movement of the actuation lever the switchable lock arrangement remains in its state.

15. The motor vehicle lock according to claim 1, wherein the motor vehicle lock comprises a central locking drive with a central locking motor for switching the switchable lock arrangement between the locked state and the unlocked state.

16. The motor vehicle lock according to claim 4, wherein the motor vehicle lock arrangement comprises a central lock actuation element for engaging the central locking lever and switching the switchable lock arrangement to the locked state, wherein the central lock actuation element can be actuated by a user for switching the switchable lock arrangement to the locked state.

17. The motor vehicle lock according to claim 5, wherein the inertial lever is configured for engaging the switchable lock arrangement and switching it to the locked state on actuation of the actuation lever during the crash condition.

18. The motor vehicle lock according to claim 7, wherein the inertial lever is configured for pivoting around a inertial lever pivot axis and is coupled to the actuation lever at the inertial lever pivot axis, in particular, wherein the actuation lever is configured for pivoting around a pawl actuation pivot axis, which pawl actuation pivot axis is offset from the inertial lever pivot axis.

19. The motor vehicle lock according to claim 9, wherein the inertial lever can be brought into a free-running position in which the inertial lever runs free without engaging the switchable lock arrangement, in particular, wherein the inertial lever is brought into the free-running position on actuation of the actuation lever in the absence of the crash condition.

20. The motor vehicle lock according to claim 10, wherein the inertial lever is pre-stressed, in particular spring-biased, toward the free-running position.
